(19) United States
(12) Patent Application Publication
(10) Pub. No.: US 2007/0002720 A1
(43) Pub. Date: Jan. 4, 2007

(54) Optical data storage medium

(75) Inventors: Hung-Chieh Cheng, Taipei (TW); Rod Huang, Taipei (TW)

Correspondence Address: BIRCH STEWART KOLASCH & BIRCH, PO BOX 747, FALLS CHURCH, VA, 22040-0747, US

(73) Assignee: PRODISC TECHNOLOGY INC.

(21) Appl. No.: 11/208,611

(22) Filed: Aug. 23, 2005

(30) Foreign Application Priority Data
Jul. 1, 2005 (TW) 094122458

(51) Int. Cl. G11B 7/24

(52) U.S. Cl. 369/275.3

(57) ABSTRACT

An optical data storage medium which has a recording layer and a reflective layer formed on a substrate with a pregroove, is characterized in that a track pitch of the pregroove is equal to or greater than 0.535 μm and less than 0.74 μm.

### BACKGROUND OF THE INVENTION

1. Field of Invention

The invention relates to an optical data storage medium and, in particular, to an optical data storage medium with high storage capacity.

2. Related Art

With increasing the demand for the high storage capacity, the optical data storage medium develops a digital versatile disc (DVD) having a higher storage capacity of equal to or even greater than 4.7 Gbytes than the conventional compact disc (CD) only having the storage capacity of 650 Mbytes. In view of having enormous market growth of recordable and rewritable DVD in further years and in order to solve its compatibility with the conventional disc player and DVD player, the standard of the recordable/rewritable DVD format includes DVD+R/DVD+RW, which is more compatible with DVD player, in addition to the conventional DVD-R, DVD-RAM, and DVD-RW.

With reference to FIG. 1, the recordable/rewritable DVD 1 is taken as an example. It comprises two 0.6 mm thick substrates 10 bonded each other. The substrate 10 has a pregroove 101 in spiral path and arranged outward from the center of the optical disc. After that, the recording layer 11, reflective layer 12, cover layer 13, and adhesive layer 14 are sequentially coated on the substrate 10. Finally, the procedure of bonding two substrates 10 brings to completion.

The data of the recordable/rewritable DVD 1 is roughly divided into a power calibration area (PCA), a recording management area (RMA), a lead-in area, data area, and a lead-out area. The PCA is provided for calibrating laser power on recording. The PMA includes identification code, serial number, and recording information. The lead-in area and the lead-out area identify the data area used for recording data.

With reference to FIG. 3, it is a sectional enlarged view showing the substrate 10. The distance between the centers of the adjacent pregroove 101 is called track pitch D. The standards of the DVD-R/RAM and DVD+R/RAM formats indicate that the track pitch is 0.74 μm. A wobble groove is called because of the wobble signal is formed along the lateral of the pregroove 101. The wobble signal contains the address in pregroove (ADIP) provided for the disc being positioned precisely with respect to the light source on recording and reproducing. Additionally, the period length of wobble signal indicated in the standard of the DVD-R/RAM format is 186T while that in the standard of the DVD+R/RAM is 32T.

As mentioned above, the storage capacity of the recordable/rewritable DVD formats including DVD-R/RAM and DVD+R/RAM are not greater than 4.7 Gbytes under the current standard books description. However, it is an inevitable trend to develop greater storage capacity of recordable/rewritable DVD. Therefore, it is a subject to provide an optical data storage medium with high storage capacity.

### SUMMARY OF THE INVENTION

In view of the foregoing, the invention is to provide an optical data storage medium with high storage capacity.

To achieve the above, an optical data storage medium of the invention, which has a recording layer and a reflective layer formed on a substrate with a pregroove, is characterized in that a track pitch of the pregroove is equal to or greater than 0.535 μm and less than 0.74 μm.

As mentioned above, the optical data storage medium of the invention is by way of reducing track pitch in the fixed area to enlarge the storage capacity. Additionally, the area of the information area is expanded by way of shifting lead-in area inward and lead-out area outward to further increase the storage capacity.

### BRIEF DESCRIPTION OF THE DRAWINGS

The invention will become more fully understood from the detailed description given herein below illustration only, and thus is not limitative of the present invention, and wherein:

FIG. 1 is a schematic view showing the conventional DVD disc;

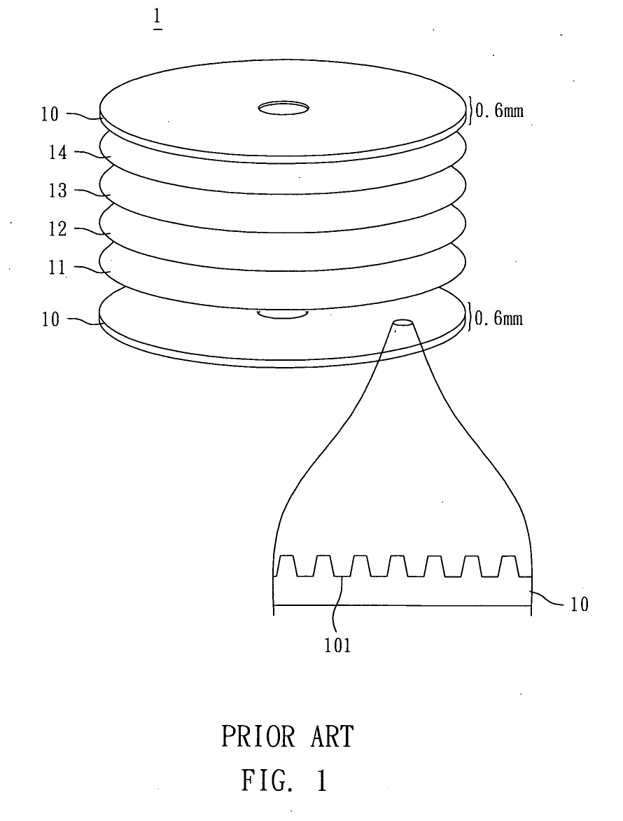

FIG. 2 is a schematic view showing the information division of the conventional DVD disc;

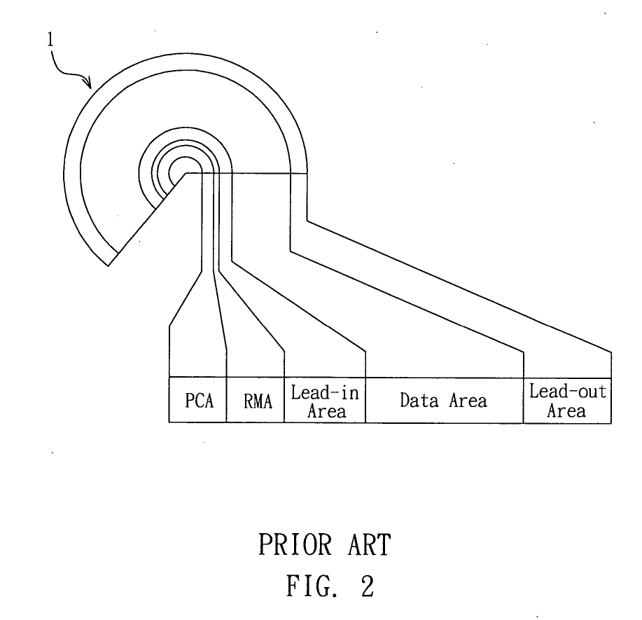

FIG. 3 is an enlarged sectional view showing the substrate of the conventional DVD disc;

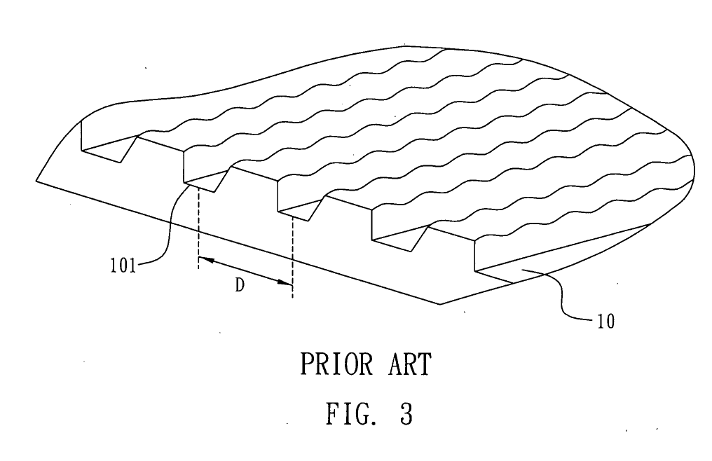

FIG. 4 is an enlarged sectional view showing an optical data storage medium according to a preferred embodiment of the invention;

FIG. 5 is a schematic view of the information division of the optical data storage medium according to a preferred embodiment of the invention; and

FIG. 6 shows a Table 1 illustrating the standard of the optical data storage medium according to a preferred embodiment of the invention.

### DETAILED DESCRIPTION OF THE INVENTION

The present invention will be apparent from the following detailed description, which proceeds with reference to the accompanying drawings, wherein the same references relate to the same elements.

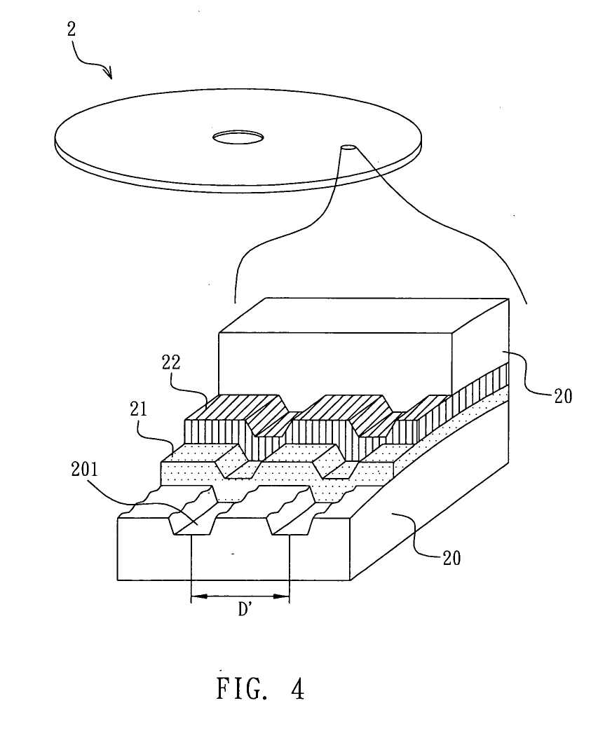

With reference to FIG. 4, the optical data storage medium 2 according to the embodiment of the invention has a recording layer 21 and a reflective layer 22 formed on a substrate 20 with a pregroove 201. The optical data storage medium 2 according to the embodiment of the invention is characterized in that a track pitch D′ of the pregroove 201 is equal to or greater than 0.535 μm and less than 0.74 cm. Additionally, after bonding another substrate 20, the optical data storage medium 2 of the present embodiment is obtained. Therefore, the storage capacity of the optical information medium 2 according to the embodiment of the invention can range from greater than 4.7 Gbytes to 6.7 Gbytes.

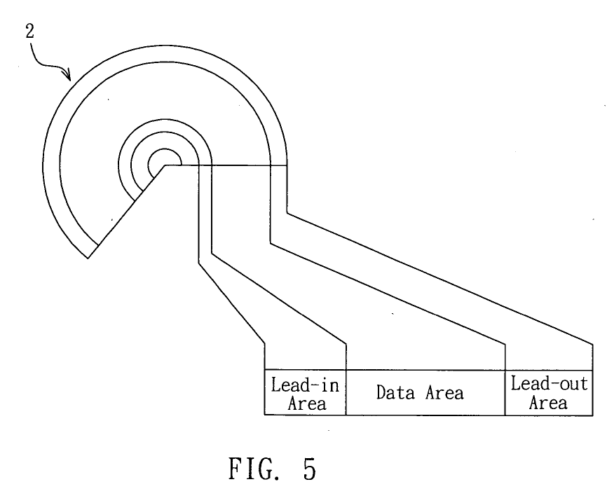

With reference to FIG. 5, the substrate 20 includes a lead-in area, a data area, and a lead-out area in order. The lead-in area and the lead-out area identify the data area. In general, the diameter of the optical data storage medium is 120 mm. In the present embodiment, the lead-in area locates between 21.9 mm and 24 mm from the center of the optical data storage medium 2 while the lead-out area locates between 58 mm to 58.488 mm from the center of the optical data storage medium 2.

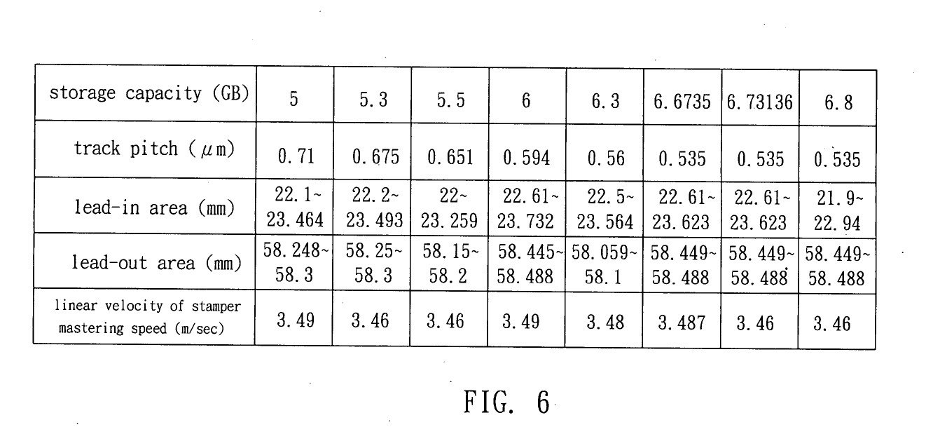

To make the content of the invention more comprehensive, the inventor collects the experimental data shown in Table 1 (as shown in FIG. 6). The different standard of the optical data storage medium 2 according to the embodiment of the invention corresponds to the different storage capacity.

The pregroove 201 of the optical data storage medium 2 according to the embodiment of the invention is a wobble groove. The wobble groove 201 having a period length is provided for precisely positioning the disc with respect to the light source on recording and reproducing.

In the present embodiment, the linear velocity of stamper mastering speed is slowed. Accordingly, the linear velocity of stamper mastering speed is equal to or less than the conventional 3.49 m/sec. Consequently, the period length of the wobble groove is equal to or less than 186T if the optical data storage medium 2 is a DVD-R or DVD-RW while the period length of the wobble groove is equal to or less than 32T if the optical data storage medium 2 is a DVD+R or DVD+RW.

Specifically, the optical data storage medium 2 having a storage capacity of 5 Gbytes is taken as an example. The pregroove 201 having the track pitch D′ of 0.71 μm is formed on the substrate 20. The lead-in area locates between 22.1 mm and 23.464 mm from the center of the optical data storage medium 2. The lead-out area locates between 58.248 mm and 58.3 mm from the center of the optical data storage medium 2. And the linear velocity of stamper mastering speed is 3.49 m/sec.

In addition, the optical data storage medium 2 having a storage capacity of 6.8 Gbytes is taken as another example. The track pitch D′ of the pregroove 201 formed on the substrate 20 is 0.535 μm. The lead-in area locates between 22.9 mm and 22.94 mm from the center of the optical data storage medium 2. The lead-out area locates between 58.449 mm and 58.488 mm from the center of the optical data storage medium 2. And the linear velocity of stamper mastering speed is 3.46 m/sec.

In conclusion, the optical data storage medium according to the embodiment of the invention is by way of reducing track pitch in the fixed area to enlarge the storage capacity. Additionally, the area of the information area is expanded by way of shifting lead-in area inward and lead-out area outward to further increase the storage capacity.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An optical data storage medium, which has a recording layer and a reflective layer formed on a substrate with a pregroove, characterized in that:
a track pitch of the pregroove is equal to or greater than 0.535 μm and less than 0.74 μm.

2. The optical data storage medium of claim 1, wherein the substrate sequentially comprises a lead-in zone, a data zone, and a lead-out zone.

3. The optical data storage medium of claim 2, wherein the lead-in zone locates between 21.9 mm and 24 mm from the center of the optical data storage medium.

4. The optical data storage medium of claim 2, wherein the lead-out zone locates between 58 mm to 58.488 mm from the center of the optical data storage medium.

5. The optical data storage medium of claim 1, wherein the pregroove is a wobble pregroove having a period length.

6. The optical data storage medium of claim 5, wherein the optical data storage medium is a DVD-R or a DVD-RW.

7. The optical data storage medium of claim 5, wherein the optical data storage medium is a DVD+R or a DVD+RW.

8. The optical data storage medium of claim 6, wherein the period length of the wobble groove is equal to or less than 186T.

9. The optical data storage medium of claim 7, wherein the period length of the wobble groove is equal to or less than 32T.
